(19) United States
(12) Patent Application Publication
(10) Pub. No.: US 2021/0125177 A1
(43) Pub. Date: Apr. 29, 2021

(54) AUTHENTICATION NETWORK FOR TRANSACTION DATA

(71) Applicant: NCR Corporation, Atlanta, GA (US)

(72) Inventor: Jon Delwyn West, Addison, TX (US)

(21) Appl. No.: 16/667,372

(22) Filed: Oct. 29, 2019

(51) Int. Cl. G06Q 20/38; H04L 9/32

(52) U.S. Cl. CPC G06Q 20/3821; H04L 9/3247; G06Q 2220/00; H04L 2209/38; H04L 2209/56; G06Q 20/3829

(57) ABSTRACT

Various embodiments herein each include at least one of systems, methods, software, and data structures of an authentication network for transaction data. One method embodiment includes electronically receiving an account identifier associated with a purchase transaction and, for each item in the purchase transaction, an item identifier and price data. The method proceeds by generating a data structure in memory for each item included in the purchase transaction. The data structure of each item includes an item identifier and respective price data. Each data structure is then signed in memory with a private key of a private/public key-pair of a merchant of the purchase transaction. The method further proceeds by transmitting each data structure generated for the purchase transaction to a location associated with the account identifier.

### BACKGROUND INFORMATION

Records of consumer purchases present many issues in modern society. Current records of consumer purchases involve issuance of paper receipts and electronic replications thereof, such as receipt images sent via email, text, or being made available in online customer accounts. Some similar solutions involve communicating formatted text of receipts in the same ways. Current records of consumer purchases also include merchants, banks, and other similar types of entities storing the transaction data, often including payment data that can include credit card data.

The consumer side of purchase records provides challenges for merchants as paper and electronic receipts are easily forged and modified in ways to facilitate purchase return fraud. Similarly, receipts are often discarded, picked up by others, taken back in to store and presented to return products that were not purchased but instead simply picked up from store shelves. The merchant side of purchase records presents great exposure to merchants to safeguard data. Consumers are growing more and more fatigued by data breaches, lack of privacy, and also being used as the product of merchants selling their data.

Today's digital receipt solutions do nothing to solve consumer security and privacy issues and allow for easy fraud to be perpetrated against merchants.

### SUMMARY

Various embodiments herein each include at least one of systems, methods, software, and data structures of an authentication network for transaction data. Such embodiments address many issues in the modern receipt and proof of purchase space of retailing as well as data security, consumer privacy, and fraud prevention.

One method embodiment includes electronically receiving an account identifier associated with a purchase transaction and, for each item in the purchase transaction, an item identifier and price data. The method proceeds by generating a data structure in memory for each item included in the purchase transaction. The data structure of each item includes an item identifier and respective price data. Each data structure is then signed in memory with a private key of a private/public key-pair of the issuer (e.g., merchant, payment processor, etc.) of the purchase transaction. The method further proceeds by transmitting each data structure generated for the purchase transaction to a location associated with the account identifier.

Another method embodiment includes receiving, via a network into an account of a consumer, a proof of purchase (POP) data structure for each item included in a purchase transaction. In such embodiments, each POP data structure is signed with a private key of the issuer (e.g., merchant, payment processor, etc.) and includes data representative of the respective item purchased and a price paid therefor. This method may then proceed by forwarding each data structure over the network to a computing system of an entity configured to receive POP data structures of the consumer. In some embodiments, the method also includes receiving, via the network, a payment from the entity.

A further embodiment is in the form of a system that includes a network interface device a computer processor, and a memory device, with instructions stored thereon, which when executed by the computer processor cause the system to perform data processing activities. The data processing activities may include electronically receiving an account identifier associated with a purchase transaction and, for each item in the purchase transaction, an item identifier and price data. The data processing activities then proceed by generating a data structure on the memory device for each item included in the purchase transaction with the data structure of each item including an item identifier and respective price data. Each data structure on the memory device is then signed with a private key of a private/public key-pair of a merchant of the purchase transaction. Each data structure may then be transmitted via the network interface device to a location associated with the account identifier.

### BRIEF DESCRIPTION OF THE DRAWINGS

FIG. 1 is a logical diagram of data structures, according to an example embodiment.

FIG. 2 is a network entity diagram, according to an example embodiment.

FIG. 3 is an illustration of data flows, according to an example embodiment.

FIG. 4 is a block diagram of a method, according to an example embodiment.

FIG. 5 is a block diagram of a method, according to an example embodiment.

FIG. 6 is a block diagram of a computing device, according to an example embodiment.

### DETAILED DESCRIPTION

Various embodiments herein each include at least one of systems, methods, software, and data structures of an authentication network for transaction data. Such embodiments address many issues in the modern receipt and proof of purchase space of retailing as well as data security, consumer privacy, and fraud prevention.

Various embodiments herein address these issues by treating each item for which a traditional purchase receipt as a verifiable claim. A verifiable claim in some such embodiments is a data structure that includes data identifying an item and at least some traditional receipt data such as price paid, data of purchase, and merchant identifying data. Such a verifiable claim data structure is also typically cryptographically signed by or for the issuing merchant and the verifiable claim data structure is electronically provided to the purchasing consumer as a digital purchase receipt. In some embodiments, such a digital purchase receipt is provided to the consumer for each item purchased. Once issued, each digital purchase receipt is a verifiable claim indicating that the consumer and whomever the consumer shares a digital purchase receipt with can verify that the claim is original, has not been tampered with, and came from a specific merchant. The digital purchase receipt is a self-proving data structure proving the consumer purchased the item.

Such embodiments address at least some types of fraudulent item returns to merchants due at least to controlled distribution of digital purchase receipts, verifiable identities of merchants and consumers, and verifiable data integrity of digital purchase receipts. Another benefit that may be realized by, merchants and merchant data processing service providers is that less underlying transaction data can be retained to process item returns. For example, a self-proving digital purchase receipt enable data to be stored therein that can later be verified internally thereto alleviating the need for such data to be retained by merchants. With less data, such as credit card data and consumer identity data, exposure from data security breaches is lessened and data security and consumer privacy regulatory compliance becomes easier.

Furthermore, consumers having possession of digital purchase receipts and generally own and control the data can share this data as they choose. For example, consumers may choose to share data with interested entities in exchange for a benefit, such as product discounts and even payment. Offers of payment, discounts, and other benefits for sharing data may be made through digital purchase receipt data marketplaces and consumers may choose to sell their data to enable the purchasers to use the data for purposes such as advertising, offers, market research, and the like.

Such embodiments provide benefits to consumers and merchants. For example, consumers who have grown tired of their data being sold by the companies they do business with can now choose which entities have access to their data as merchants, for the most part, will not be storing the data and therefore cannot share it. Further, consumers get paid or receive other benefits for sharing their data. At the same time, the architecture of the solutions herewith enable consumers to stop sharing of their data at any time and to have their data “forgotten” by those with whom their data has been shared.

Merchants can also benefit through reductions in receipt-related fraud, cost effective security and privacy compliance, new opportunities for revenue or reduced operating expenses by implementing such systems, and enhanced advertising and customer relationship services available from companies that process consumer digital receipt data.

In some embodiments, the digital purchase receipts are supported by a blockchain platform and the consumer payments are made in cryptocurrency. Both blockchain and cryptocurrency further enable consumer privacy while enabling trust and payment.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

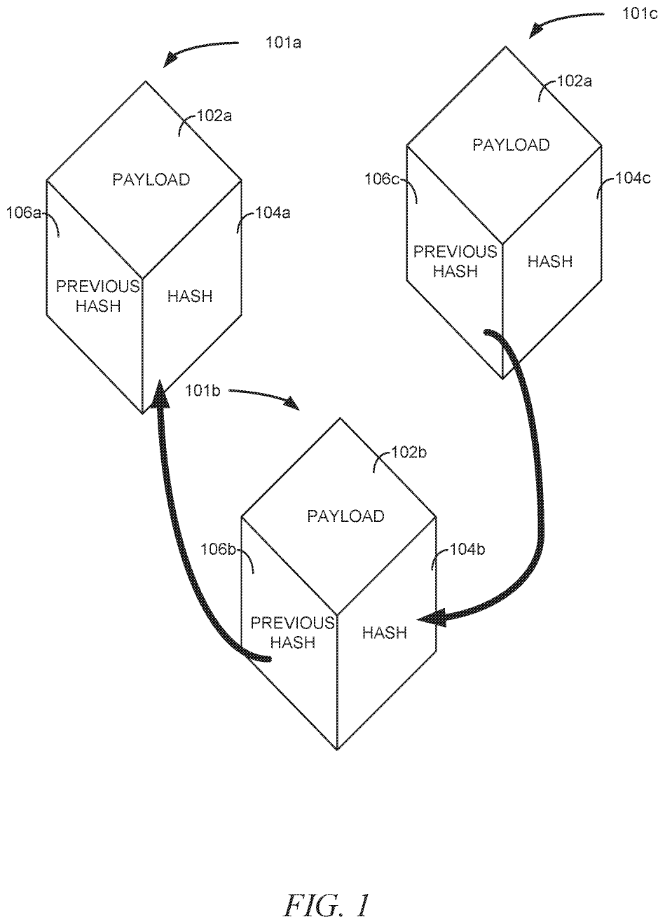

FIG. 1 is a logical diagram of data structures 101a, 101b, 101c, according to an example embodiment. The data structures 101a, 101b, 101c are examples of digital purchase receipts of some embodiments. In some embodiments, the data structures 101a, 101b, 101c are blocks in a blockchain. However, in some other embodiments the data structures 101a, 101b, 101c are represented in the blockchain, such as in a ledger, only by reference by a hash value or other representation. In such embodiments, the consumer possesses the receipt, such as in a digital wallet or other storage mechanism, and that receipt can be verified as authentic through the data that is stored in the blockchain. The blockchain, or other similar data structure of a particular embodiment, also includes a flag that may be set to indicate the issued receipt is no longer valid, such as due to a product return, a reissuance of the receipt, or other reason.

The data structures 101a, 101b, 101c are each issued for an individual item purchased by a consumer from a merchant. For example, when a consumer purchases three items, three data structures will be generated and provided to the consumer, one of each item. Later, should one of the purchased items be returned or a warranty claim made, the data structure corresponding to that item is provided electronically as needed.

The data structures 101a, 101b, 101c are built on a blockchain platform. Thus, generally speaking, the data structures 101a, 101b, 101c each include purchase transaction data as data payload 102a, 102b, 102c. The data structures also include a hash value 104a, 104b, 104c that is generated from the data of the data payload 102a, 102b, 102c of the receptive data structure. The data structures 101a, 101b, 101c also include a pointer to a previous data structure, such as data structure 101c pointer 106c pointing to the hash 104b of prior data structure 101b. A sequence of the data structures 101a, 101b, 1011c adds to the verifiable trust of the solution as it aids in abilities to detect tampering. Further, each data structure 101a, 101b, 101c includes a representation in a ledger that may be stored and updated in one or more locations. The ledger in such embodiments includes hash values and sequencing data that may be utilized to verify data of the data structures 101a, 101b, 101c.

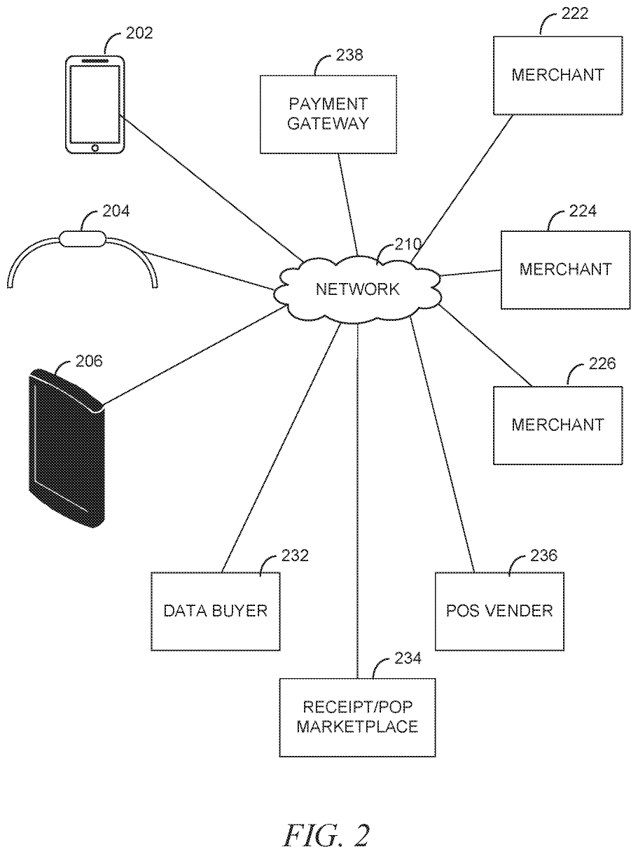

FIG. 2 is a network entity diagram 200, according to an example embodiment.

The diagram 200 includes a network 210 to which numerous entities are connected. The entities include a plurality of consumer devices 202, 204, 206 that include digital wallet applications thereon that may store and manage consumer data. The consumer data may include data digital purchase receipts, digital identity data (DID), and cryptocurrency.

The entities connected to the network 210 also include at least one, but typically many, merchant computing systems 222, 224, 226. The merchant computing systems 222, 224, 226 may be or include point of sale (POS) terminals, backend transaction processing systems, and the like. The merchant computing systems 22, 224, 226 may perform many functions, but at least include issuance of digital purchase receipts and maintaining a digital purchase receipt ledger.

The diagram 200 also illustrates a digital purchase receipt data marketplace 234, a data buyer system 232, a POS system vendor system 236, and a payment gateway 238. The digital purchase marketplace 234 is a system that provides facilities purchases digital purchase receipt data of consumers by the operator of the data buyer system 232.

The network 210 may be the Internet in some embodiments. The network 210, in some embodiments, may also include or be one or more other networks, such as local and wide area networks, a value added network, a secure financial network, and other network types.

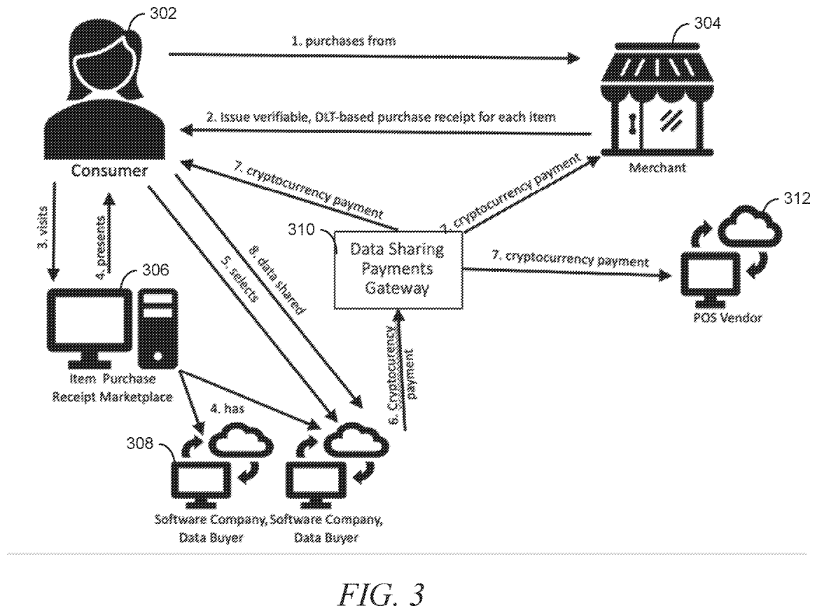

Operation of some embodiments including the entities of the diagram 200 are provided with regard to FIG. 3.

FIG. 3 is an illustration 300 of data flows, according to an example embodiment. The illustration 300 includes a consumer 302, which actually represents a computing resource of a consumer and an app that executes thereon such as a digital wallet. The illustration 300 also includes a merchant 304 computing system, a digital purchase receipt data marketplace 306, data buyer 308 computing systems, a data sharing payment gateway, and a POS system vendor computing system 312. The item purchase market place 306 in some embodiments is an online marketplace that the consumer 302 visits, views data purchase offers provide by data buyers 308, and accepts. The data sharing payments gateway 310 is a computing resource that provides abilities to the data buyers to send payments to consumers, merchants, POS system vendor computing system 312, and the like.

In operation, the consumer 302 purchases an item from the merchant 304. The merchant 304 then issues a digital purchase receipt to the consumer 302. The consumer 302 may then visit the item purchase receipt marketplace 306 to view offers from data buyers 308. The consumer 302 then selects an offer and informs the data buyer 308. The data may be shared by the consumer 302 with the data buyer 308 at this point to trigger a payment or the payment may be made by the data buyer 308 first and then the data shared. Regardless, when the payment is to be made, the data buyer 308 may send the payment through a data sharing payment gateway 310 that provides access to payment networks, such as a cryptocurrency payment network, a banking network, a store credit network for credit at stores of a merchant, and the like. The data sharing payment gateway 310 may also include rules that are applied to distribute payment funds to various entities that may be involved in the ecosystem of the illustration 300. For example, the merchant 304 and the POS vendor may receive payment for participating in and facilitating they data sharing and payment solution.

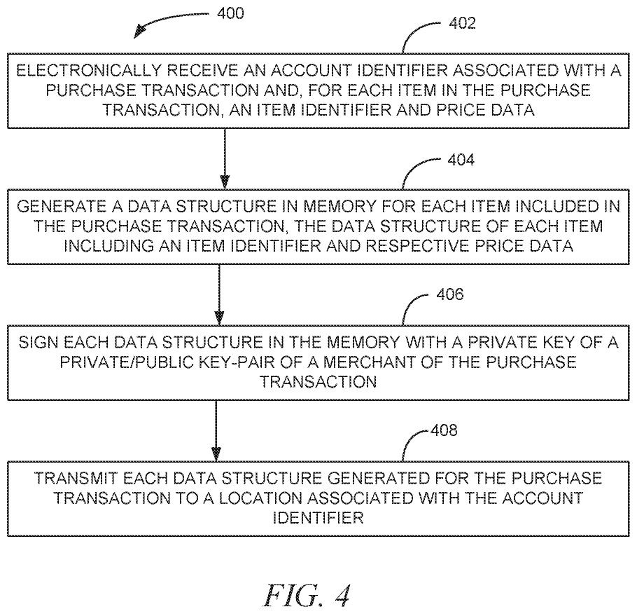

FIG. 4 is a block diagram of a method 400, according to an example embodiment. The method 400 is an example of a method that may be performed by, or in park by, a merchant computing system 222, 224, 226 of FIG. 2.

The method 400 includes electronically receiving 402 an account identifier associated with a purchase transaction and, for each item in the purchase transaction, an item identifier and price data. The method 400 continues by generating 404 a data structure in memory for each item included in the purchase transaction. The data structure generated 404 for each item including an item identifier and respective price data. The method 400 then signs 406 each data structure in the memory with a private key of a private/public key-pair of a merchant of the purchase transaction. Each data structure is then transmitted 408 to a location associated with the account identifier. In some embodiments, each data structure, or a portion of data therefrom, may be stored to a ledger that stores data for purposes of ensuring the veracity of the generated 404 data structures can be confirmed.

The location to which each data structure is transmitted 408 may be a digital wallet of a consumer. In another embodiment of the method 400, the account identifier is an address of the location associated with the account identifier to which each data structure is transmitted 408.

In some embodiments, the data structure generated 404 for each product further includes the account identifier. The account identifier in some such embodiments ties a data structure to a particular individual that may be known in another system, such as a customer loyalty account. In some embodiments, generating 404 the data structure includes adding further data of the transaction thereto including data identifying a merchant and a date of the purchase transaction. In these and other embodiments, the data structures which are also referred to herein as digital purchase receipts provide proof of purchase.

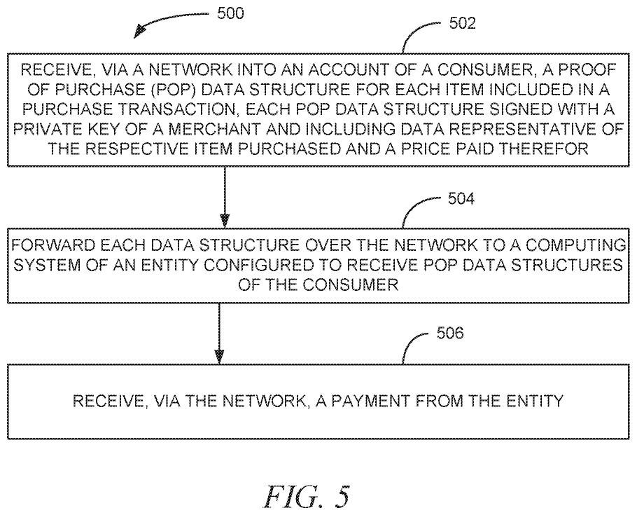

FIG. 5 is a block diagram of a method 500, according to an example embodiment. The method 500 is an example of a method that may be performed on a consumer device, such as one of the consumer devices 202, 204, 206 of FIG. 2. The consumer device on which the method 500 is performed may be a consumer mobile device, such as a smartphone, a smartwatch, a tablet, a laptop computer, a smart controller of an automobile, and the like. The consumer device may include a digital wallet app or application or other software thereon that includes programming to perform the method 500.

The method 500 includes receiving 502, via a network into an account of a consumer, a proof of purchase data structure, which may also be referred to as a digital purchase receipt, for each item included in a purchase transaction. In some embodiments, each received 502 POP data structure is signed with a private key of a merchant and includes data representative of the respective item purchased and a price paid therefor. The method 500 further includes forwarding 504 each data structure over the network to a computing system of an entity configured to receive POP data structures of the consumer. The method 500 may then receiving 506, via the network, a payment from the entity. The payment may be received as a unit of cryptocurrency and a representation thereof is stored in a digital wallet on the consumer mobile device.

In some embodiments, the POP data structure is received 502 via the network from a computing system of the merchant.

In some embodiments, the method 500 includes providing the POP data structure to a merchant computing system when returning the item represented in the data structure. In such embodiments, the POP data structure is subject to validation by the merchant computing system through validation of the signing.

In some embodiments, the method 500 includes providing the POP data structure to a manufacture computing system when registering the item represented in the data structure with the manufacture (e.g., warranty registration). In such embodiments, the POP data structure is subject to validation by the manufacture computing system through validation of the signing.

In some embodiments, the method 500 includes providing the POP data structure to a product review computing system when returning the item represented in the data structure. In such embodiments, the POP data structure is subject to validation by the product computing system through validation of the signing. This is done to help ensure that a consumer is reviewing a product or service that they have actually purchased.

In some embodiments, the method 500 includes providing the POP data structure to a friend or family member computing system when the item represented in the data structure was purchased as a gift and the buyer wants to provide the receive a “gift receipt” so that receive can return the gift.

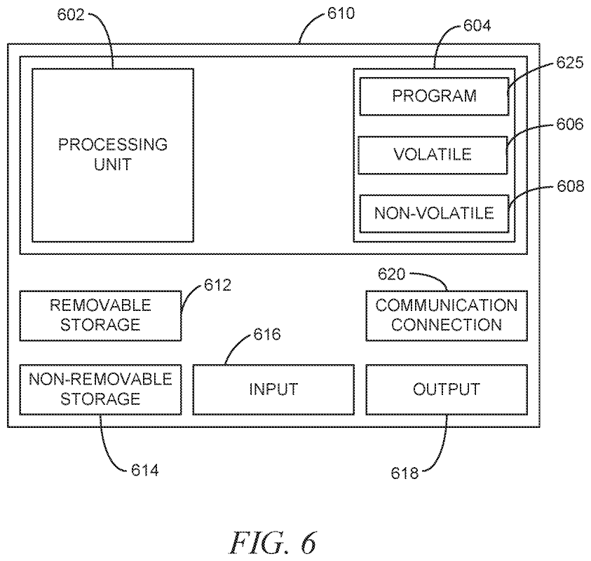

FIG. 6 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 610, may include a processing unit 602, memory 604, removable storage 612, and non-removable storage 614. Although the example computing device is illustrated and described as computer 610, the computing device may be in different forms in different embodiments. For example, the computing device may instead be a smartphone, a tablet, smartwatch, or other computing device including the same or similar elements as illustrated and described with regard to FIG. 6. Devices such as smartphones, tablets, and smartwatches are generally collectively referred to as mobile devices. Further, although the various data storage elements are illustrated as part of the computer 610, the storage may also or alternatively include cloud-based storage accessible via a network, such as the Internet.

Returning to the computer 610, memory 604 may include volatile memory 606 and non-volatile memory 608. Computer 610 may include—or have access to a computing environment that includes a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 610 may include or have access to a computing environment that includes input 616, output 618, and a communication connection 620. The input 616 may include one or more of a touchscreen, touchpad, mouse, keyboard, camera, one or more device-specific buttons, one or more sensors integrated within or coupled via wired or wireless data connections to the computer 610, and other input devices. The computer 610 may operate in a networked environment using a communication connection 620 to connect to one or more remote computers, such as database servers, web servers, and other computing device. An example remote computer may include a personal computer (PC), server, router, network PC, a peer device or other common network node, or the like. The communication connection 620 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 620 may also or alternatively include a transceiver device, such as a BLUETOOTH® device that enables the computer 610 to wirelessly receive data from and transmit data to other BLUETOOTH™ devices. For example, the communication connection 620 in some embodiments may be a BLUETOOTH® connection with a wireless headset that includes a speaker and a microphone. As such in these embodiments, a BLUETOOTH® transceiver device may be the audio output device as described elsewhere herein.

Computer-readable instructions stored on a computer-readable medium are executable by the processing unit 602 of the computer 610. A hard drive (magnetic disk or solid state), CD-ROM, and RAM are some examples of articles including a non-transitory computer-readable medium. For example, various computer programs 625 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
electronically receiving an account identifier associated with a purchase transaction and, for each item in the purchase transaction, an item identifier and price data;
generating a data structure in memory for each item included in the purchase transaction, the data structure of each item including an item identifier and respective price data;
signing each data structure in the memory with a private key of a private/public key-pair of a merchant of the purchase transaction; and
transmitting each data structure generated for the purchase transaction to a location associated with the account identifier.

2. The method of claim 1, wherein the data structure for each product further includes the account identifier.

3. The method of claim 1, wherein the account identifier is an address of the location associated with the account identifier to which each data structure is transmitted.

4. The method of claim 1, wherein the account identifier identifies a digital wallet to which each data structure is to be transmitted.

5. The method of claim 1, further comprising:
storing each data structure over a network location to a ledger.

6. The method of claim 5, wherein each data structure is a block of a blockchain and the ledger is a blockchain ledger.

7. The method of claim 1, wherein the data structure of an item is an electronic proof of purchase of the respective item.

8. The method of claim 1, wherein the data structure includes further data of the transaction including data identifying the merchant and a date of the purchase transaction.

9. The method of claim 1, further comprising:
receiving a payment with regard to at least one of the transmitted data structures subsequent to the respective data structure having been forwarded to an entity as authorized by a holder of the account.

10. A method comprising:
receiving, via a network into an account of a consumer, a proof of purchase (POP) data structure for each item included in a purchase transaction, each POP data structure signed with a private key of a merchant and including data representative of the respective item purchased and a price paid therefor;
forwarding each data structure over the network to a computing system of an entity configured to receive POP data structures of the consumer; and
receiving, via the network, a payment from the entity.

11. The method of claim 10, wherein the POP data structure is received via the network from a computing system of the merchant.

12. The method of claim 10, wherein the account of the consumer is a digital wallet of the consumer.

13. The method of claim 12, wherein the payment is received as a unit of cryptocurrency and is stored to the digital wallet.

14. The method of claim 9, further comprising:
providing the POP data structure to a merchant computing system when returning the item represented in the data structure, the POP data structure subject to validation by the merchant computing system through validation of the signing.

15. A system comprising:
a network interface device;
a computer processor; and
a memory device, with instructions stored thereon, which when executed by the computer processor cause the system to perform data processing activities comprising:
electronically receiving an account identifier associated with a purchase transaction and, for each item in the purchase transaction, an item identifier and price data;
generating a data structure on the memory device for each item included in the purchase transaction, the data structure of each item including an item identifier and respective price data;
signing each data structure on the memory device with a private key of a private/public key-pair of a merchant of the purchase transaction; and
transmitting, via the network interface device, each data structure generated for the purchase transaction to a location associated with the account identifier.

16. The method of claim 15, further comprising:
storing each data structure over a network location to a ledger.

17. The method of claim 16, wherein the account identifier identifies a digital wallet to which each data structure is to be transmitted.

18. The method of claim 17, wherein each data structure is a block of a blockchain and the ledger is a blockchain ledger.

19. The method of claim 15, wherein the data structure of an item is an electronic proof of purchase of the respective item.

20. The method of claim 15, further comprising:
receiving a payment with regard to at least one of the transmitted data structures subsequent to the respective data structure having been forwarded to an entity as authorized by a holder of the account.
